(19) United States
(12) Patent Application Publication
(10) Pub. No.: US 2004/0153765 A1
(43) Pub. Date: Aug. 5, 2004

(54) Data communication system and data conversion device

(76) Inventor: Dieter Prifling, Mintraching (DE)

Correspondence Address: MICHAEL BEST & FRIEDRICH, LLP, 100 E WISCONSIN AVENUE, MILWAUKEE, WI, 53202, US

(21) Appl. No.: 10/466,151

(22) PCT Filed: Dec. 21, 2001
(86) PCT No.: PCT/EP01/15220

(30) Foreign Application Priority Data
Jan. 11, 2001 (DE) 101 01 034.6

(51) Int. Cl. H04L 1/22

(52) U.S. Cl. 714/18

(57) ABSTRACT

The present invention relates to a data communication system with a data processing device comprising a network interface for the transmission of data from and to a network. To achieve a universal network compatibility for the data processing device, independent of the structures thereof and, furthermore, a rapid economical networking, the network-interface is formed by a mass storage interface for the data processing device and a data conversion device connected therewith, which converts mass storage data into network data and vice versa. The conversion of network data into mass storage data and vice versa, permits data delivered by means of the network to be treated by the data processing device as if stored on a local hard disk in the data processing device.

### BACKGROUND OF THE INVENTION

1. Field of the Invention

The present invention relates to data communication systems, and in particular to a data conversion device for a data communication system, the data conversion device comprising a mass storage interface connectable to a data processing device for exchanging mass storage data, and a network interface for the transmission of data from and to a network. The present invention also relates to a method for requesting network data through a data processing device via a network.

2. Description of the Related Art

The networking of the most different data processing devices, such as PC-compatible systems, embedded systems or workstations and servers, via various communication channels offers a considerably improved performance spectrum over the stand-alone operation of such a data processing device. Examples of such a networking are the internet or other network protocols via any desired network interfaces, such as serial, Ethernet, GSM (Global System for Mobile Communication), ISDN (Integrated Services Digital Network), DSL (Dialog Scripting Language) or UMTS (Universal Mobile Telecommunications System).

As a rule, the data processing device must be equipped with a corresponding network interface for such a networking operation. A basic prerequisite, however, is that the data processing device provides the internal bus structure required for the respective network interface. It might therefore happen that an already existing data processing device is not suited for adaptation to a desired communication technology.

### SUMMARY OF THE INVENTION

Therefore, an improved data communication system is provided with a data processing device that can achieve universal network compatibility for the data processing device, independent of the structures of the data processing device and, furthermore, a rapid economical networking.

According to one embodiment, a data conversion device for a data communication system comprises a mass storage interface connectable to a data processing device for exchanging mass storage data, and a network interface for the transmission of data from and to a network. The data conversion device is configured as a hardware component such that it converts mass storage data into network data and vice versa. The data conversion device further comprises a file system generator which is adapted to convert the network data into sector data.

According to another embodiment, a data communication system comprises a first data processing device and a data conversion device, the data conversion device comprising a mass storage interface connectable to the first data processing device for exchanging mass storage data, and a network interface for transmitting data from and to a network. The data conversion device is designed as a hardware component such that it converts mass storage data into network data and vice versa. The data conversion device further comprises a file system generator which is adapted to convert the network data into sector data.

According to still another embodiment, a method for requesting network data through a data processing device via a network comprises the following steps:

requesting and receiving network data through the network interface of a data conversion device;

converting the network data into a format of mass storage data;

outputting the mass storage data via a mass storage interface of the data conversion device;

receiving the mass storage data via a mass storage interface of the data processing device;

building up a file system within the data conversion device to obtain sector data that are presented to the data processing device.

### BRIEF DESCRIPTION OF THE DRAWINGS

The accompanying drawings are incorporated into and form a part of the specification for the purpose of explaining the principles of the invention. The drawings are not to be construed as limiting the invention to only the illustrated and described examples of how the invention can be made and used. Further features and advantages will become apparent from the following and more particular description of the invention as illustrated in the accompanying drawings, wherein:

FIG. 1 is a block diagram of a data communication system according to the invention;

FIG. 2 is a block diagram of the data communication system according to a preferred embodiment;

FIG. 3 is a flow diagram regarding the steps of requesting network data through a data-processing device;

FIG. 4 is a flow diagram regarding the transmission of mass storage data through a data processing device.

### DETAILED DESCRIPTION OF THE INVENTION

The illustrated embodiments of the present invention will be described with reference to the figure drawings, wherein like elements and structures are indicated by like reference numbers.

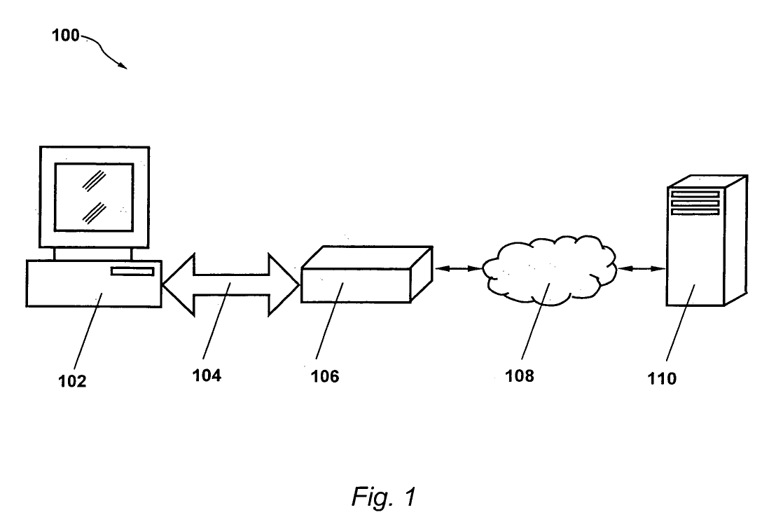

Referring now to FIG. 1, the data communication system 100 according to the invention comprises a data processing device 102 that is connectable to a network 108 via a mass storage interface 104 and an inventive data conversion device 106 connected to the latter. Furthermore, a second data processing device 110 can be connected to the network 108; the data processing device 110 can e.g. assume the function of a server. The data communication system 100 as is here described permits the networking of the data processing device 102 in quite a general way by using the mass storage interface 104. Networking means any kind of interconnection of the data processing devices, irrespective of the technology used or the quality of the communication channel. Examples are the internet or other network protocols via various media, e.g. serial data transmission, Ethernet, GSM (Global System for Mobile Communication), ISDN (Integrated Services Digital Network), DSL (Dialog Subscriber Line), UMTS (Universal Mobile Telecommunications Systems), or future technologies that do not exist yet. In this context the data processing device 102 stands for any type of digital systems, irrespective of the technology used or the size and scope of information processing. Examples thereof are PC-compatible systems embedded systems, workstations or servers. Mass storage systems, such: as CD, disk drives, DVD, hard disk drives, streamers or magneto-optical mass storage devices, are so wide-spread that it can be assumed that every data processing device comprises at least one mass storage connection. Different interfaces exist for coupling the data processing device to the respective mass storage device: IDE, ATA (Bus Attachment), ATAPI (Attachment Packet Interface), SCSI (Small Computer Systems Interface), USB (Universal Serial Bus), or FireWire. The data conversion device 106 according to the invention therefore finds the necessary internal bus structure in any given data processing device.

During standard operation, the described data communication system 100 shows a transparent behavior vis-à-vis the network 108 and also vis-à-vis the data processing device 102. This means that no additional software or driver is needed. The system is thus independent of the operating systems and file systems used. With the data communication system 100 according to the invention, an adaptation of already existing data processing devices to new communication technologies is possible. The data processing devices need not be developed specifically for this purpose, nor is any modification required. Moreover, already existing, but also new data processing devices are given the option of an automatic software updating. Time and costs are thereby saved both in the development phase and during final use. Software can be serviced centrally, but can also be operated in a decentralized independent way and updated automatically, if necessary. The data communication system 100 according to the invention permits not only an information exchange between the data processing devices 102 and 110, but also their remote start. Decentralized mass storage devices are thus replaced by a network connection, e.g. internet or intranet.

With the data communication system 100 according to the invention, it is possible to replace any type of mass storage device by an image on a central server that can be used by many clients at the same time, and costs can thereby be saved to a considerable extent. This is above all of great importance to so-called “thin clients” and other mobile clients on the internet.

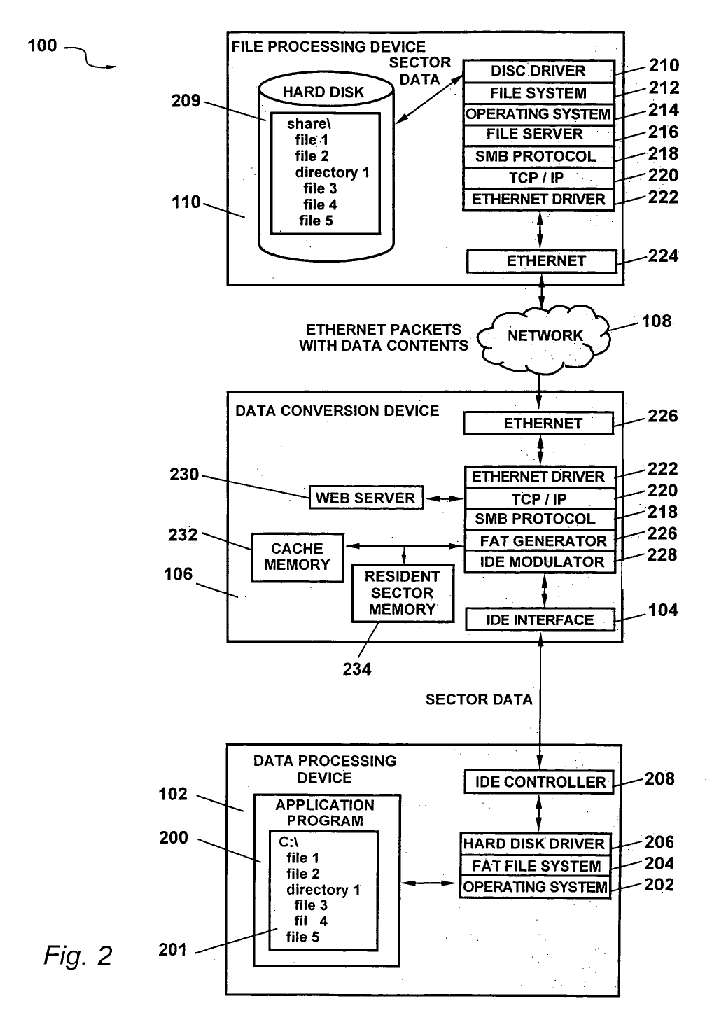

FIG. 2 shows in detail the data communication system 100 of the invention according to a preferred embodiment. According to the invention, a data processing device 102 comprises, inter alia, an IDE controller 208. For the actuation of a hard disk via said IDE controller 206 the data processing device 102 has a hard disk driver 206. For the allocation of individual data to a specific sector of the hard disk the data processing device 102 has a so-called FAT (File Allocation Table) file system 204. Moreover, the data processing device 102 is equipped with an operating system 202. Whenever the data processing device 102 needs specific files for an application program 200, the structure of said files being schematically shown under reference numeral 201, said files are requested via the hard disk driver and the IDE interface. Said request via the mass storage interface is for the data processing device 102 as if it would be passed on to a real mass storage device.

The data sent from the data processing device 102 are transmitted via the IDE interface of the data conversion device 104 and converted there into Ethernet data according to the SMB protocol 218 under the network protocol TCP/IP 220. The request is passed on via the Ethernet interface 226 of the data conversion device 106 to the network 108 in the form of Ethernet packets. A further data processing device 110 can be connected to the network 108. It also comprises an Ethernet interface 224 and a hard disk 209. The data processing device 110 is equipped with an Ethernet driver 222 and with the software 220 and 218 needed for the TCP/IP protocol and the SMB protocol. Furthermore, it has a file server-216, an operating system 214 and a file system 212. A disk driver 210 is responsible for driving the hard disk 209. The request received via the Ethernet interface 224 is further processed by the file server, and the sector data looked for are provided with the help of the disk driver 210 from the hard disk 209. Subsequently, via the Ethernet connection 224, Ethernet packets are transmitted with the requested file contents via the network 108 to the Ethernet interface 226 of the data conversion device 106. A FAT generator 226 adapts said data to the structure needed in the data processing device 102. Said sector data can be temporarily stored in a cache memory 132 and additionally in a resident sector memory 234. The data read from the hard disk 209 are however not necessarily stored in the data conversion device 106. Instead of this, they can also be obtained dynamically. The data processing device 110 is connected to the data conversion device via Ethernet either directly or via further routers to the internet. The data need not have been processed specifically for the data conversion device. According to a preferred development of the invention the data of the first data processing device 102 are presented as an FAT-compatible file system. The FAT file system is supported by all popular operating systems. As a rule, other operating systems that are not based on FAT can also be implemented.

Depending on the form in which the data 201 needed by the application program 200 are stored on the hard disk 209 of the data processing device 110, the data conversion device 106 operates in one of two different modes. In a so-called image mode the data processing device 110 contains a so-called disk image, i.e., an image of a hard disk that was specifically prepared for use with the data conversion device 106 of the invention. This permits full independence from the respective operating system. Moreover, the data can contain any desired file system.

In the so-called file mode, the data processing device 110 contains a file system in the form of a recursive tree. The data conversion device 106 dynamically builds up a virtual FAT file system which is presented to the first data processing device 102. The actual data will only be read if needed by the operating system 202.

The second data processing device 110 need not be modified with respect to the data conversion device 106. The operating mode is above all suited for access to data that are on an external internet server.

According to a preferred embodiment the data conversion device uses TCP/IP as the connection protocol. Use is either made of HTTP or SMB (CIFS) to access data. The use of HTTP enables the data conversion device 106 to read data from any web server in the internet. SMB enables the data conversion device 106 to read data from any desired Windows workstation or a Windows server. This will then be a conventional Windows peer-to-peer data access. A special configuration in the Windows PC is not needed. The operating system Linux also contains SMB support in the form of the so-called samba packet. To support all of the UNIX systems, NFS may also be implemented.

According to a further preferred embodiment the data conversion device 106 comprises an IDE interface 104. This permits the use of such a data conversion device 106 in most of the standard PC systems. However, a so-called “compact flash” interface may also be provided. The data conversion device can replace an existing hard disk or mass storage device, or may be used as a supplementary device therefor. The data conversion device 106 can be operated as a master and also as a slave.

An installed web server 230 allows the configuration of the data conversion device 106. The data conversion device 106 can thus be operated via a browser from any other system in the network 108 without any additional software. Hence, a configuration is possible from the data processing device 102 and the data processing device 110.

In the image mode, it is possible to use any desired file system 204 because the hard disk image on the hard disk 209 is stored in accordance with the file system needed in the data processing device 102. In the file mode, the FAT generator 226 of the data conversion device 106 must be designed accordingly. Such file systems are e.g. FAT12, FAT16, FAT32, EXT2 FS (Linux) or NTFS. The operating system 202 has no impact on the design of the data conversion device 106. Possible operating systems in which full operability can be exploited are e.g. Windows 9x/ME, Windows NT/NT Embedded, Windows CE, DOS VxWorks, or Linux.

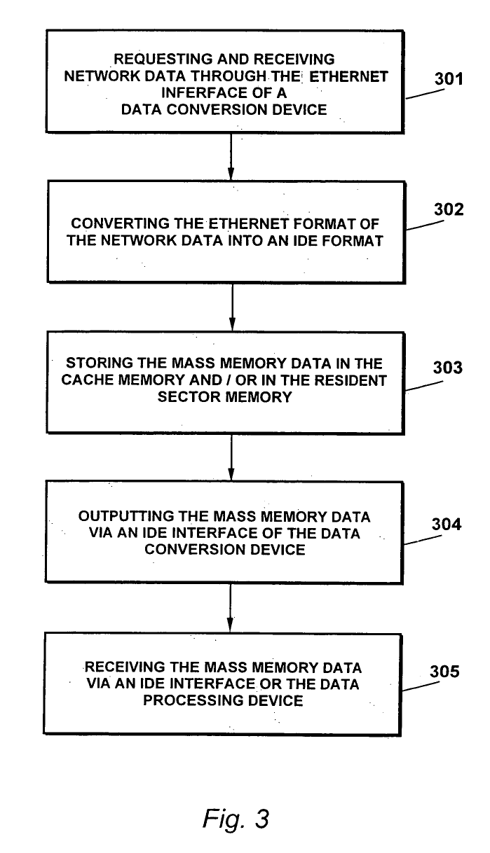

FIG. 3 is a flow diagram showing the individual steps taken for transmitting network data to the data processing device 102. In step 301, network data are requested and received by the Ethernet interface 226 of the data conversion device 106. Subsequently, in step 302, the Ethernet format is converted into an IDE format. A FAT generator 226 is needed in this step for allocating the desired file system to the data. Optionally, in step 303, the mass storage data (mass memory data) obtained in this way can be stored in the cache memory 232 and/or in the resident sector memory 234. In step 304, the mass storage data are output via an IDE interface 104 of the data conversion device 106. Finally, in step 305, the mass storage data are received via an IDE interface of the data processing device 102. They can now be made accessible via the hard disk driver 206 and the FAT file system 204 and also via the operating system 202 to the application program 200.

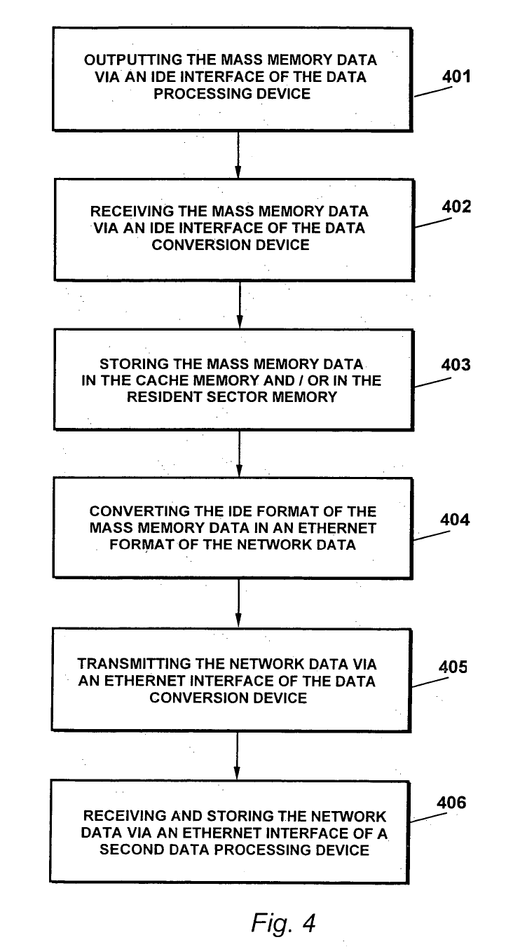

FIG. 4 sketches the individual steps in the form of a flow diagram that are taken during storage of data, which were generated in the data processing device 102, on the hard disk 209. For the data processing device 102, the subsequent operation does not differ from the conventional storing of data on a conventional mass storage device. In step 401, mass storage data are output via the IDE interface to the data processing device 102. The data are received via the IDE interface 104 of the data conversion device 106 in step 402. The mass storage data can be stored optionally (step 403) in the cache memory 232 and/or in the resident sector memory 234. In step 404, the IDE format of the mass storage data is converted into an Ethernet format for network data. The protocol TCP/IP is preferably used as the protocol. In step 405, the network data are output via an Ethernet interface 226 of the data conversion device to the network 108. These data are received by the second data processing device 110 via the Ethernet interface 224. They are then stored on the hard disk 209.

An essential advantage of the data communication system according to the invention is that the use of the mass storage interface of the data processing device as a network interface may ensure that also those data processing devices are connectable to a network interface that have no network interface, but only a mass storage interface. When the data conversion device provided in the data communication system of the invention is realized as an external module, the solution of the invention has the additional advantage that the data processing device can be networked without any intervention into the same. The conversion of network data into mass storage data and vice versa permits data delivered via the network to be treated by the data processing device as if stored on a local hard disk in the data processing device.

According to an advantageous embodiment, the data conversion device is connectable via an Ethernet interface to the network. This means that the network data are Ethernet packets. This ensures compatibility with a wide-spread network protocol and universal application.

In the PC field, the IDE (Integrated Drive Electronics) interface is very wide-spread. Therefore, for achieving maximum compatibility the mass storage interface is an IDE interface according to a further preferred embodiment.

When the data conversion device is equipped with a storage device in which the network data are stored, this offers the advantage that even in case of an interruption of the connection to the network the already requested network data are available. To provide said data in such a way that the data conversion device acts for the PC as a mass storage device, the network data are preferably stored as mass storage data.

According to a further advantageous embodiment, the connection between the data conversion device and the network can be interrupted and for the period of the interruption the data processing device can access the data stored in the storage device. This has the advantage that the costs for a permanent network connection can be saved.

According to a further advantageous embodiment, the data conversion device additionally comprises a web server for the configuration of the data conversion device. This may be a processor with the corresponding software, but also the corresponding software program that can be requested by the processor of the data, processing device. This has the advantage that the data conversion device can be operated via a browser from any other system in the network without any additional software. A configuration of the data conversion device is thus possible from the data processing device and also from any further component of the network.

According to a further advantageous embodiment of the present invention, the data communication system can be connected to a second data processing device with at least one hard disk via the network. This has the advantage that the software can be serviced centrally, but operated in a decentralized independent way and updated automatically, if necessary.

In a further advantageous development of the data communication system according to the invention, a data system is stored in the form of a hard disk image on the hard disk of the second data processing device. The use of such a so-called “disk image” offers the advantage of achieving full independence from the operating system. The data may contain any desired file system.

According to an alternative advantageous embodiment, a file system of a recursive tree is stored on the hard disk of the second data processing device. On the basis thereof, the data conversion device builds up a virtual FAT file system in a dynamic way, the FAT file system being presented to the first data processing device. The actual data will only be read when said data are needed by the operating system of the first data processing device. This offers the advantage that the second data processing device does not have to know anything about the existence of the data conversion device.

According to a further advantageous embodiment, the data conversion device uses the protocol TCP/IP (Transmission Control Protocol/Internet Protocol) as the connection protocol. HTTP (Hyper Text Transfer Protocol), SMB (Server Message Block) or CIFS (Common Internet File System) is used for accessing data. HTTP enables the data conversion device to read data from any web server in the internet. SMB enables the data conversion device to read data at any Windows workstation or a corresponding server. This has the advantage that a conventional Windows peer-to-peer file access is concerned and that no special configuration is needed for the Windows PC. Linux also includes SMB support in the form of the so-called samba packet. To support all of the UNIX systems, NFS (Network File System) may be used.

While the invention has been described with respect to the physical embodiments constructed in accordance therewith, it will be apparent to those skilled in the art that various modifications, variations and improvements of the present invention may be made in the light of the above teachings and within the purview of the appended claims without departing from the spirit and intended scope of the invention.

In addition, those areas in which it is believed that those ordinary skilled in, the art are familiar have not been described herein in order not to unnecessarily obscure the invention described herein.

Accordingly, it is to be understood that the invention is riot to be limited by the specific illustrated embodiments but only by the scope of the appended claims.

What is claimed is:

1. A data conversion device for a data communication system, the data conversion device comprising a mass storage interface connectable to a data processing device for exchanging mass storage data, and a network interface for the transmission of data from and to a network, and the data conversion device being configured as a hardware component such that it converts mass storage data into network data and vice versa,
wherein the data conversion device further comprises a file system generator which is adapted to convert the network data into sector data.

2. The data conversion device according to claim 1, wherein the file system generator is a file allocation table generator.

3. The data conversion device according to claim 1, wherein the mass storage interface is an IDE interface.

4. The data conversion device according to claim 3, wherein the IDE interface is connected via an IDE emulator to the file system generator.

5. The data conversion device according to claim 1, wherein the, network interface is an Ethernet interface.

6. The data conversion device according to claim 1, wherein the data conversion device comprises a storage device in which the network data are stored.

7. The data conversion device according to claim 6, wherein the data conversion device stores the network data as mass storage data.

8. The data conversion device according to claim 1, wherein the data-conversion device further comprises a web server for the configuration of the data conversion device.

9. A data communication system comprising a first data processing device and a data conversion device, the data conversion device comprising a mass storage interface connectable to the first data processing device for exchanging mass storage data, and a network interface for transmitting data from and to a network, and the data conversion device being designed as a hardware component such that it converts mass storage data into network data and vice versa,
wherein the data conversion device further comprises a file system generator which is adapted to convert the network data into sector data.

10. The data communication system according to claim 9, wherein the file system generator is a file allocation table generator.

11. The data communication system according to claim 9, wherein the mass storage interface is an IDE interface.

12. The data communication system according to claim 11, wherein the IDE interface is connected via an IDE emulator to the file system generator.

13. The data communication system according to claim 9, wherein the network interface is an Ethernet interface.

14. The data communication system according to claim 9, wherein the data conversion device comprises a storage device in which the network data are stored.

15. The data communication system according to claim 14, wherein the data conversion device stores the network data as mass storage data.

16. The data communication system according to claim 9, wherein the connection between the data conversion device and the network can be interrupted and that for the period of the interruption the data processing device accesses the data stored in the storage device.

17. The data communication system according to claim 9, wherein the data conversion device further comprises a web server for the configuration of the data conversion device.

18. The data communication system according to claim 9, wherein same can be connected via the network to a second data processing device which includes at least one hard disk.

19. The data communication system according to claim 18, wherein a file system is stored on the hard disk in the form of a hard disk image.

20. The data communication system according to claim 18, wherein a file system is stored on the hard disk in the form of a recursive tree.

21. The data communication system according to claim 9, wherein the data conversion device uses TCP/IP as a connection protocol for the network.

22. The data communication system according to claim 21, wherein the data conversion device is configured to access data under HTTP.

23. The data communication system according to claim 21, wherein the data conversion device is configured to access data under SMB.

24. A method for requesting network data through a data processing device via a network, comprising the following steps:
requesting and receiving network data through the network interface of a data conversion device;
converting the network data into a format of mass storage data;
outputting the mass storage data via a mass storage interface of the data conversion device;
receiving the mass storage data via a mass storage interface of the data processing device,
characterized by the following step:
building up a file system within the data conversion device to obtain sector data that are presented to the data processing device.

25. The method according to claim 24, wherein in the step of requesting and receiving network data, the network data are Ethernet packets with file contents.

26. The method according to claim 24, wherein after the step of requesting and receiving network data through the network interface of a data conversion device it further comprises the step of
temporarily storing the network data in a cache memory.

27. The method according to claim 24, wherein after the step of converting the network data into a format of mass storage data, the method further comprises the step of
storing the mass storage data in a resident memory.

28. The method according to claim 24, wherein the mass storage interface is an IDE interface.
